(19) United States
(12) Patent Application Publication
(10) Pub. No.: US 2011/0037962 A1
(43) Pub. Date: Feb. 17, 2011

(54) POLARIZATION CONVERTING UNIT, ILLUMINATION OPTICAL SYSTEM, EXPOSURE APPARATUS, AND DEVICE MANUFACTURING METHOD

(75) Inventor: Osamu TANITSU, Kumagaya (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/821,742

(22) Filed: Jun. 23, 2010

Related U.S. Application Data
(60) Provisional application No. 61/346,983, filed on May 21, 2010.

(30) Foreign Application Priority Data
Aug. 17, 2009 (JP) 2009-188173

(51) Int. Cl. G03B 27/54; G02B 5/30; G03B 27/32; F21V 9/14

(52) U.S. Cl. 355/67; 359/485; 355/77; 362/19

(57) ABSTRACT

According to one embodiment, a polarization converting unit configured to convert incident light into light in a predetermined polarization state has a first optical element and a second optical element. The first optical element has a plurality of first regions, and at least two adjacent first regions have respective different thicknesses so as to have different polarization conversion properties. Likewise, the second optical element also has a plurality of second regions, and at least two adjacent second regions have different polarization conversion properties. The first and second optical elements are arranged so that a light beam having passed through one first region is incident to two adjacent second regions, whereby the sum of thicknesses of the first and second optical elements is varied depending upon a passing position of light.

### CROSS-REFERENCE TO RELATED APPLICATIONS

This application is based upon and claims the benefit of priority from Japanese Patent Application No. 2009-188173, filed on Aug. 17, 2009, and Provisional Application No. 61/346,983, filed on May 21, 2010, the entire contents of which are incorporated herein by reference.

### BACKGROUND

1. Field

One embodiment of the invention relates to a polarization converting unit, an illumination optical system, an exposure apparatus, and a device manufacturing method. More particularly, the present invention relates to an illumination optical system suitably applicable to an exposure apparatus for manufacturing such devices as semiconductor devices, imaging devices, liquid crystal display devices, and thin film magnetic heads by lithography.

2. Description of the Related Art

In a typical exposure apparatus of this type, a light beam emitted from a light source travels through a fly's eye lens as an optical integrator to form a secondary light source as a substantial surface illuminant consisting of a large number of light sources. The secondary light source generally means a predetermined light intensity distribution on an illumination pupil. The light intensity distribution on the illumination pupil will be referred to hereinafter as a “pupil intensity distribution.” The illumination pupil is defined as a position such that an illumination target surface becomes a Fourier transform plane of the illumination pupil by action of an optical system between the illumination pupil and the illumination target surface. In the case of the exposure apparatus, the illumination target surface corresponds to a mask or a wafer.

Beams from the secondary light source are condensed by a condenser optical system and then superposedly illuminate the mask on which a predetermined pattern is formed. Light passing through the mask travels through a projection optical system to be focused on the wafer, whereby the mask pattern is projected (or transferred) onto the wafer to effect exposure thereof. The pattern formed on the mask is a highly integrated one. For this reason, an even illuminance distribution must be obtained on the wafer in order to accurately transfer this microscopic pattern onto the wafer.

There is a recently proposed illumination optical system achieving an illumination condition suitable for faithfully transferring the microscopic pattern in any direction (cf. Japanese Patent No. 3246615). This illumination optical system is so set that the secondary light source of an annular shape is formed on the illumination pupil at or near the rear focal plane of the fly's eye lens and that the polarization state of the light passing through the annular secondary light source is converted into a state of polarization rotating in the circumferential direction of the secondary light source (which will be referred to hereinafter as a “circumferentially polarized state”).

### SUMMARY

According to an embodiment of the invention, a polarization converting unit is arranged on an optical axis of an optical system and configured to convert a polarization state of propagation light passing along an optical-axis direction corresponding to the optical axis, and comprises: a first optical element; and a second optical element. The first optical element is comprised of an optical material with an optical rotatory power, which is arranged so as to have a crystal axis coincident or parallel with the optical-axis direction, and has a plurality of first regions with respective polarization conversion properties to rotate linearly polarized light incident thereto as the propagation light, around the optical-axis direction. On the other hand, the second optical element is comprised of an optical material with an optical rotatory power, which is arranged on the exit side of the first optical element and which is arranged so as to have a crystal axis coincident or parallel with the optical-axis direction, and has a plurality of second regions with respective polarization conversion properties to rotate linearly polarized light incident thereto as the propagation light, around the optical-axis direction. In such a configuration, at least two first regions selected from the plurality of first regions have their respective thicknesses different from each other in the optical-axis direction, and the plurality of first regions are arranged so that two first regions with mutually different polarization conversion properties are adjacent to each other. At least two second regions selected from the plurality of second regions have their respective thicknesses different from each other in the optical-axis direction, and wherein the plurality of second regions are arranged so that two second regions with mutually different polarization conversion properties are adjacent to each other. Furthermore, the first and second optical elements are arranged so that a light beam having passed through one first region of the first optical element is incident to two adjacent second regions of the second optical element, whereby the sum of respective thicknesses in the optical-axis direction of first and second regions through which a first reference axis parallel to the optical-axis direction passes is different from the sum of respective thicknesses in the optical-axis direction of other first and second regions through which a second reference axis parallel to the optical-axis direction and different from the first reference axis passes.

According to an embodiment of the invention, A polarization converting unit is arranged on an optical axis of an optical system and configured to convert a polarization state of propagation light passing along an optical-axis direction corresponding to the optical axis, and comprises: a first optically rotatory member which rotates linearly polarized light incident thereto as the propagation light, around the optical-axis direction; and a second optically rotatory member which rotates linearly polarized light incident as the propagation light thereto through the first optically rotatory member, around the optical-axis direction. The first optically rotatory member is comprised of an optical material with an optical rotatory power, which is arranged so as to have a crystal axis coincident or parallel with the optical-axis direction, and has a first thickness distribution of thicknesses in the optical-axis direction different at a plurality of locations. On the other hand, the second optically rotatory member is comprised of an optical material with an optical rotatory power, which is arranged so as to have a crystal axis coincident or parallel with the optical-axis direction, and has a second thickness distribution of thicknesses in the optical-axis direction different at a plurality of locations. Furthermore, in such a configuration, the first and second optically rotatory members are arranged so that the sum of respective thicknesses in the optical-axis direction at predetermined locations in the first and second optically rotatory members through which a first reference axis parallel to the optical-axis direction passes is different from the sum of respective thicknesses in the optical-axis direction at other locations in the first and second optically rotatory members through which a second reference axis parallel to the optical-axis direction and different from the first reference axis passes.

As described above, a pupil intensity distribution in a circumferentially polarized state with high continuity can be achieved.

For purposes of summarizing the invention, certain aspects, advantages, and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIGS. 1A and 1B are exemplary drawings schematically showing a configuration of an exposure apparatus according to an embodiment of the present invention;

FIG. 2 is an exemplary drawing schematically showing an internal configuration of a spatial light modulating unit;

FIG. 3 is an exemplary drawing for explaining an action of a spatial light modulator in the spatial light modulating unit;

FIG. 4 is an exemplary partial perspective view of a major part of the spatial light modulator;

FIGS. 5A and 5B are exemplary drawings showing a configuration of a first polarization converting member and an annular light intensity distribution formed on an entrance plane thereof;

FIGS. 6A and 6B are exemplary drawings showing a configuration of a second polarization converting member and an annular light intensity distribution formed on an entrance plane thereof;

FIGS. 7A and 7B are exemplary drawings showing a positional relation between optically rotatory members in the first polarization converting member and optically rotatory members in the second polarization converting member;

FIG. 8 is an exemplary drawing showing an annular light intensity distribution in a substantially continuous, circumferentially polarized state formed on an illumination pupil immediately after the second polarization converting member;

FIG. 9 is an exemplary drawing showing an optical path in the spatial light modulating unit in a setup where a tiltable plane-parallel plate is set in a second posture;

FIG. 10 is an exemplary drawing showing an optical path in the spatial light modulating unit in a setup where the tiltable plane-parallel plate is set in a third posture;

FIGS. 11A to 11C are exemplary drawings showing another configuration example of the first and second polarization converting members;

FIG. 12 is an exemplary drawing showing an annular light intensity distribution in a substantially continuous, circumferentially polarized state formed on the illumination pupil immediately after the second polarization converting member;

FIG. 13 is an exemplary drawing showing a configuration of the first polarization converting member formed using wave plates;

FIG. 14 is an exemplary drawing showing a configuration of the second polarization converting member formed using wave plates;

FIG. 15 is an exemplary drawing for explaining a polarization conversion action in a modification example using the wave plates;

FIG. 16 is an exemplary flowchart showing manufacturing blocks of semiconductor devices; and

FIG. 17 is an exemplary flowchart showing manufacturing blocks of a liquid crystal device such as a liquid crystal display device.

### DETAILED DESCRIPTION

Various embodiments according to the invention will be described hereinafter with reference to the accompanying drawings.

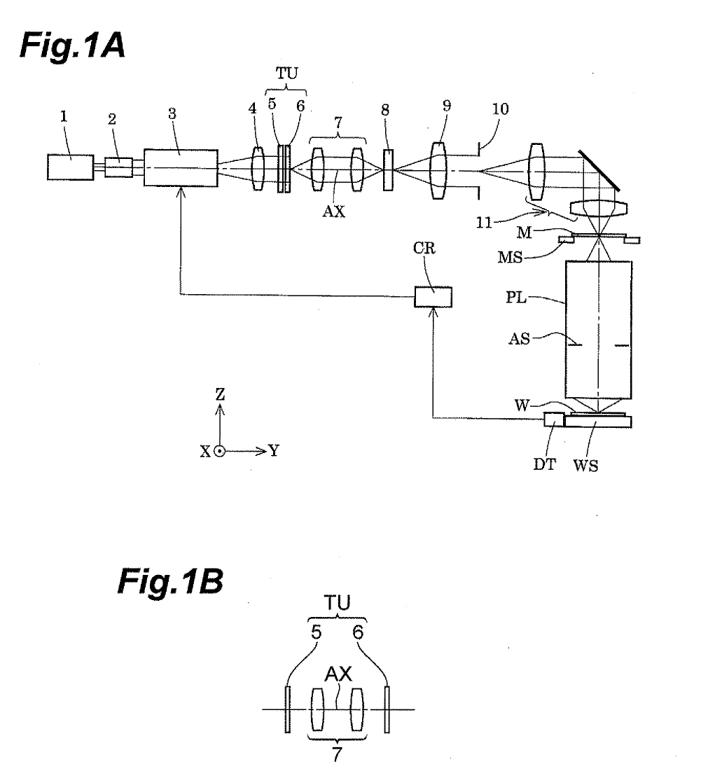

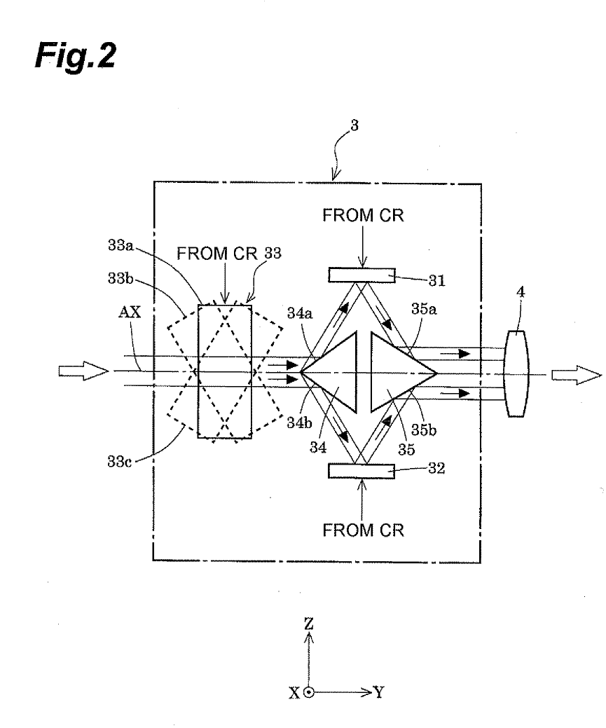

FIG. 1A is an exemplary drawing schematically showing a configuration of an exposure apparatus according to an embodiment of the present invention and FIG. 1B an exemplary drawing showing a modification example of a polarization converting unit TU. FIG. 2 is an exemplary drawing schematically showing an internal configuration of a spatial light modulating unit shown in FIG. 1A. In FIG. 1A, the Z-axis is set along a direction of a normal to a transfer surface (exposed surface) of a wafer W being a photosensitive substrate, the Y-axis along a direction parallel to the plane of FIGS. 1A and 1B in the transfer surface of the wafer W, and the X-axis along a direction normal to the plane of FIGS. 1A and 1B in the transfer surface of the wafer W.

With reference to FIG. 1A, exposure light (illumination light) from a light source 1 is supplied to the exposure apparatus of the present embodiment. The light source 1 applicable herein is, for example, an ArF excimer laser light source to supply light at the wavelength of 193 nm or a KrF excimer laser light source to supply light at the wavelength of 248 nm. The light emitted from the light source 1 travels through a beam sending unit 2 and a spatial light modulating unit 3 to enter a relay optical system 4. The beam sending unit 2 has functions to guide the incident light from the light source 1 to the spatial light modulating unit 3 while converting the light into light having a cross section of appropriate size and shape, and to actively correct variation in position and variation in angle of the light incident to the spatial light modulating unit 3.

The spatial light modulating unit 3, as shown in FIG. 2, is provided with a pair of spatial light modulators 31 and 32 arranged in parallel in the illumination optical path. Each spatial light modulator 31, 32 has a plurality of mirror elements arranged two-dimensionally and controlled individually. In the optical path on the light source side (on the left in FIG. 2) with respect to the pair of spatial light modulators 31, 32, there are a plane-parallel plate 33 tillable relative to the optical axis AX, and a deflecting member 34 arranged in order from the entrance side of light. A deflecting member 35 is arranged in the optical path on the mask side (on the right in FIG. 2) with respect to the pair of spatial light modulators 31, 32.

The plane-parallel plate 33 and deflecting member 34 selectively guide the light incident through the beam sending unit 2 to the spatial light modulating unit 3, to at least one spatial light modulator out of the pair of spatial light modulators 31, 32. It is assumed hereinafter for easier understanding of description that the light from the light source 1 is divided into two beams by the deflecting member 34, one divided beam is guided to the first spatial light modulator 31, and the other divided beam is guided to the second spatial light modulator 32. The deflecting member 35 guides the light having traveled via the first spatial light modulator 31 and the light having traveled via the second spatial light modulator 32, to the relay optical system 4. A specific configuration and action of the spatial light modulating unit 3 will be described later.

The light emitted from the spatial light modulating unit 3 travels via the relay optical system 4 to enter the polarization converting unit TU having a pair of polarization converting members 5 and 6 arranged as adjacent to each other along the optical axis AX. The configuration and action of each polarization converting member 5, 6, i.e., the configuration and action of the polarization converting unit TU will be described later. The relay optical system 4 is set so that its front focus position is approximately coincident with a position of an array plane where a plurality of mirror elements of each spatial light modulator 31, 32 are arranged and so that its rear focus position is approximately coincident with the position of the pair of polarization converting members 5, 6. As described below, the light having traveled via each spatial light modulator 31, 32 variably forms a light intensity distribution according to postures of the mirror elements at the position of the pair of polarization converting members 5, 6.

The light, which forms the light intensity distribution at the position of the pair of polarization converting members 5, 6, travels through a relay optical system 7 to enter a micro fly's eye lens (or fly's eye lens) 8. The relay optical system 7 sets the position of the pair of polarization converting members 5, 6 and the entrance plane of the micro fly's eye lens 8 optically conjugate with each other. Therefore, the light having traveled via the spatial light modulating unit 3 forms a light intensity distribution in the same contour as the light intensity distribution formed at the position of the pair of polarization converting members 5, 6, on the entrance plane of the micro fly's eye lens 8.

The micro fly's eye lens 8 is, for example, an optical element consisting of a large number of microscopic lenses with a positive refractive power arrayed vertically and horizontally and densely, and is constructed by forming the microscopic lens group by etching of a plane-parallel plate. In the micro fly's eye lens, different from the fly's eye lens consisting of mutually isolated lens elements, the large number of microscopic lenses (microscopic refracting faces) are integrally formed without being isolated from each other. However, the micro fly's eye lens is an optical integrator of the same wavefront division type as the fly's eye lens in terms of the configuration wherein the lens elements are arranged vertically and horizontally.

A rectangular microscopic refracting face as a unit wavefront dividing face in the micro fly's eye lens 8 is a rectangular shape similar to a shape of an illumination field to be formed on a mask M (and, in turn, similar to a shape of an exposure region to be formed on the wafer W). It is also possible to use, for example, a cylindrical micro fly's eye lens as the micro fly's eye lens 8. The configuration and action of the cylindrical micro fly's eye lens are disclosed, for example, in U.S. Pat. No. 6,913,373.

The light incident to the micro fly's eye lens 8 is two-dimensionally divided by the large number of microscopic lenses to form a secondary light source (substantial surface illuminant consisting of a large number of small light sources: pupil intensity distribution) having much the same light intensity distribution as the light intensity distribution formed on the entrance plane, on an illumination pupil at or near its rear focal plane. Light from the secondary light source formed on the illumination pupil immediately after the micro fly's eye lens 8 is incident to an illumination aperture stop (not shown). The illumination aperture stop is arranged at or near the rear focal plane of the micro fly's eye lens 8 and has an aperture (light transmitting part) of a shape corresponding to the secondary light source.

The illumination aperture stop is configured so as to be optionally loaded into or unloaded from the illumination optical path and so as to be switchable with a plurality of aperture stops having respective apertures different in size and shape. A switching method of the illumination aperture stops can be, for example, the well-known turret method or slide method or the like. The illumination aperture stop is arranged at a position approximately optically conjugate with an entrance pupil plane of a projection optical system PL described below, and defines a range of the secondary light source contributing to illumination. It is also possible to omit installation of the illumination aperture stop.

Beams of the light from the secondary light source limited by the illumination aperture stop travel through a condenser optical system 9 to illuminate a mask blind 10 in a superimposed manner. In this manner, a rectangular illumination field according to the shape and focal length of the rectangular microscopic refracting faces of the micro fly's eye lens 8 is formed on the mask blind 10 as an illumination field stop. Beams of light passing through a rectangular aperture (light transmitting part) of the mask blind 10 are subjected to condensing action of an imaging optical system 11 and thereafter superposedly illuminate the mask M on which a predetermined pattern is formed. Namely, the imaging optical system 11 forms an image of the rectangular aperture of the mask blind 10 on the mask M.

Light transmitted by the mask M held on a mask stage MS travels through the projection optical system PL to form an image of the mask pattern on the wafer (photosensitive substrate) W held on a wafer stage WS. In this manner, the pattern of the mask M is sequentially projected onto each of exposure regions on the wafer W by carrying out full-shot exposure or scan exposure while two-dimensionally driving and controlling the wafer stage WS in a plane (XY plane) perpendicular to the optical axis AX of the projection optical system PL and, therefore, while two-dimensionally driving and controlling the wafer W.

The exposure apparatus of the present embodiment is provided with a pupil intensity distribution measuring unit DT for measuring a pupil intensity distribution on the pupil plane of the projection optical system PL on the basis of the light having traveled through the projection optical system PL, and a control unit CR for controlling each spatial light modulator 31, 32 in the spatial light modulating unit 3 on the basis of the measurement result by the pupil intensity distribution measuring unit DT. The pupil intensity distribution measuring unit DT is provided, for example, with a CCD imaging unit having an image pickup plane arranged at a position optically conjugate with the pupil position of the projection optical system PL and monitors a pupil intensity distribution as to each point on the image plane of the projection optical system PL (i.e., a pupil intensity distribution formed at the pupil position of the projection optical system PL by light incident to each point). The detailed configuration and action of the pupil intensity distribution measuring unit DT can be known, for example, with reference to U.S. Patent Application Laid-Open No. 2008/0030707.

In the present embodiment, the mask M (and the wafer W eventually) arranged on an illumination target surface of the illumination optical system is illuminated by Köhler illumination using the secondary light source formed by the micro fly's eye lens 8, as a light source. For this reason, the position where the secondary light source is formed is optically conjugate with the position of an aperture stop AS of the projection optical system PL and the plane where the secondary light source is formed can be called an illumination pupil plane of the illumination optical system. Typically, the illumination target surface (the plane where the mask M is arranged or the plane where the wafer W is arranged in the case where the illumination optical system is considered to include the projection optical system PL) is an optical Fourier transform plane with respect to the illumination pupil plane. The pupil intensity distribution is a light intensity distribution (luminance distribution) on the illumination pupil plane of the illumination optical system or on a plane optically conjugate with the illumination pupil plane.

When the number of divisions of the wavefront by the micro fly's eye lens 8 is relatively large, the overall light intensity distribution formed on the entrance plane of the micro fly's eye lens 8 demonstrates a high correlation with the overall light intensity distribution (pupil intensity distribution) of the entire secondary light source. For this reason, the light intensity distributions on the entrance plane of the micro fly's eye lens 8 and at a position approximately optically conjugate with the entrance plane, i.e., immediately after the second polarization converting member 6 (therefore, immediately after the polarization converting unit TU) can also be called pupil intensity distributions. In the configuration shown in FIG. 1A, the beam sending unit 2, spatial light modulating unit 3, and relay optical system 4 constitute a distribution forming optical system which forms the pupil intensity distribution on the illumination pupil immediately after the polarization converting unit TU on the basis of the light from the light source 1.

The internal configuration and action of the spatial light modulating unit 3 will be described below in detail. With reference to FIG. 2, the plane-parallel plate 33 is configured so as to be rotatable around an axis (not shown) extending across the optical axis AX in the X-direction. The plane-parallel plate 33 as a halving glass takes a first posture indicated by solid line 33a in FIG. 2, a second posture indicated by dashed line 33b, or a third posture indicated by dashed line 33c, in accordance with a command from the control unit CR. In the plane-parallel plate 33 set in the first posture indicated by solid line 33a, its entrance plane and exit plane become perpendicular to the optical axis AX and, therefore, parallel to the XZ plane.

The second posture indicated by dashed line 33b is achieved by rotating the plane-parallel plate 33 by a predetermined angle counterclockwise in FIG. 2 from the first posture. The third posture indicated by dashed line 33c is a posture symmetric with the second posture with respect to the first posture and is achieved by rotating the plane-parallel plate 33 by a predetermined angle clockwise in FIG. 2 from the first posture. It is also possible to control the plane-parallel plate 33 in an optional posture between the second posture and the third posture as needed.

The deflecting members 34 and 35 have a form of a prism mirror of a triangular prism shape extending in the X-direction, for example. The deflecting member 34 has a pair of reflecting surfaces 34a and 34b directed toward the light source and a ridge line between the reflecting surfaces 34a and 34b extends across the optical axis AX in the X-direction. The deflecting member 35 has a pair of reflecting surfaces 35a and 35b directed toward the mask and a ridge line between the reflecting surfaces 35a and 35b extends across the optical axis AX in the X-direction. The deflecting members 34, 35 can also be made, for example, by providing a reflecting film of aluminum, silver, or the like on side faces of a member of a triangular prism shape made of a non-optical material like metal or an optical material like quartz. As another example, it is also possible to form the deflecting members 34, 35 as respective mirrors.

When the plane-parallel plate 33 is set in the first posture indicated by solid line 33a, a parallel beam incident along the optical axis AX to the spatial light modulating unit 3 passes straight through the plane-parallel plate 33 without being refracted by the entrance plane and exit plane thereof and thereafter is incident to the deflecting member 34. The beam reflected on the first reflecting surface 34a of the deflecting member 34 is incident to the first spatial light modulator 31 and the beam reflected on the second reflecting surface 34b is incident to the second spatial light modulator 32. The beam modulated by the first spatial light modulator 31 is reflected on the first reflecting surface 35a of the deflecting member 35 to be guided to the relay optical system 4. The beam modulated by the second spatial light modulator 32 is reflected on the second reflecting surface 35b of the deflecting member 35 to be guided to the relay optical system 4.

It is assumed hereinafter for simplicity of description that the pair of spatial light modulators 31 and 32 have the same configuration and that the array plane of the mirror elements of the first spatial light modulator 31 and the array plane of the mirror elements of the second spatial light modulator 32 are arranged in symmetry with respect to a plane including the optical axis AX and being parallel to the XY plane. Namely, each spatial light modulator 31, 32 is arranged so that the array plane of its mirror elements is parallel to the optical axis AX. It is also assumed that the first reflecting surface 34a and the second reflecting surface 34b of the deflecting member 34 and the first reflecting surface 35a and the second reflecting surface 35b of the deflecting member 35 are arranged in symmetry with respect to the plane including the optical axis AX and being parallel to the XY plane.

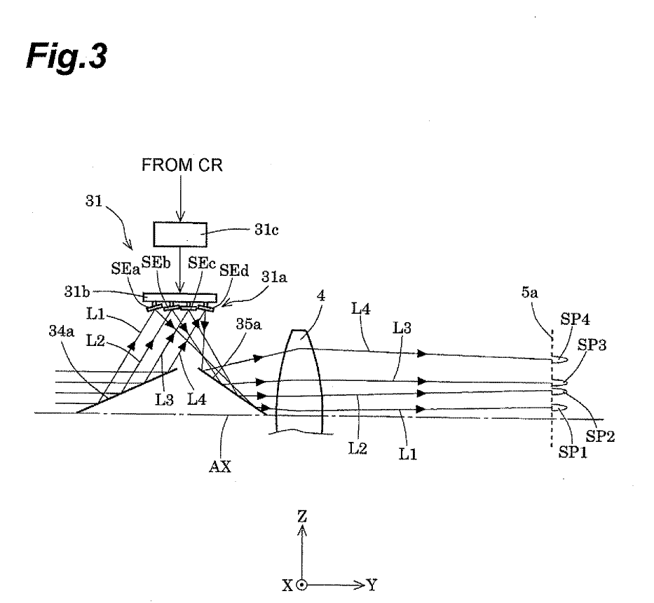

Therefore, the configuration and action of the pair of spatial light modulators 31, 32 in the spatial light modulating unit 3 will be described without redundant description as to the second spatial light modulator 32 from that of the first spatial light modulator 31 and with focus on the first spatial light modulator 31. The spatial light modulator 31, as shown in FIG. 3, is provided with a plurality of mirror elements 31a arrayed two-dimensionally along the XY plane, a base 31b holding the mirror elements 31a, and a drive unit 31c for individually controlling and driving postures of the mirror elements 31a through a cable (not shown) connected to the base 31b.

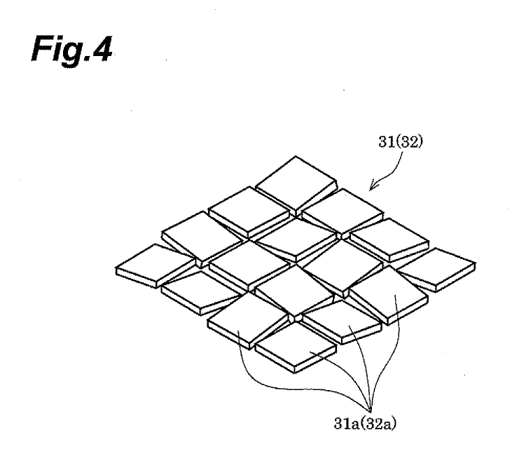

The spatial light modulator 31 (32), as shown in FIG. 4, is provided with a plurality of small mirror elements 31a (32a) arrayed two-dimensionally and it variably imparts spatial modulations according to incidence positions of incident light, to the incident light and emits spatially modulated beams. For simplicity of description and illustration, FIGS. 3 and 4 show a configuration example in which the spatial light modulator 31 (32) has 4×4=16 mirror elements 31a (32a), but in fact the spatial light modulator has much more mirror elements 31a (32a) than sixteen elements.

With reference to FIG. 3, among a group of rays traveling along the direction parallel to the optical axis AX to impinge upon the first reflecting surface 34a of the deflecting member 34 (not shown in FIG. 3) to be reflected thereon toward the spatial light modulator 31, a ray L1 is incident to a mirror element SEa out of the mirror elements 31a, and a ray L2 is incident to a mirror element SEb different from the mirror element SEa. Similarly, a ray L3 is incident to a mirror element SEc different from the mirror elements SEa, SEb and a ray L4 is incident to a mirror element SEd different from the mirror elements SEa-SEc. The mirror elements SEa-SEd impart respective spatial modulations set according to their positions, to the rays L1 to L4.

When the spatial light modulator 31 is in a standard state in which the reflecting surfaces of all the mirror elements 31a are set along one plane (XY plane), it is configured so that rays incident to the reflecting surface 34a along the direction parallel to the optical axis AX travel to be reflected by the spatial light modulator 31 and thereafter reflected into the direction approximately parallel to the optical axis AX by the first reflecting surface 35a of the deflecting member 35 (not shown in FIG. 3). The array plane of the mirror elements 31a of the spatial light modulator 31 is positioned at or near the front focus position of the relay optical system 4, as described above.

Therefore, the output rays reflected and given a predetermined angle distribution by the mirror elements SEa-SEd of the spatial light modulator 31 form predetermined light intensity distributions SP1-SP4 at the position of the pair of polarization converting members 5, 6 (position indicated by dashed line 5a in FIG. 3). Furthermore, the output rays form a light intensity distribution corresponding to the light intensity distributions SP1-SP4 on the entrance plane of the micro fly's eye lens 8. Namely, the relay optical system 4 converts angles given to the output rays by the mirror elements SEa-SEd of the spatial light modulator 31 to positions on the pair of polarization converting members 5, 6 being a far field region (Fraunhofer diffraction region) of the spatial light modulator 31.

Similarly, rays modulated by the second spatial light modulator 32 form light intensity distributions according to postures of the mirror elements 32a at the position of the pair of polarization converting members 5, 6 and, in turn, on the entrance plane of the micro fly's eye lens 8. In this manner, the light intensity distribution (pupil intensity distribution) of the secondary light source formed by the micro fly's eye lens 8 becomes a distribution corresponding to a composite distribution consisting of a first light intensity distribution formed on the entrance plane of the micro fly's eye lens 8 by the first spatial light modulator 31 and the relay optical systems 4, 7 and a second light intensity distribution formed on the entrance plane of the micro fly's eye lens 8 by the second spatial light modulator 32 and the relay optical systems 4, 7. The first light intensity distribution and the second light intensity distribution may be those completely different from each other or those overlapping in part or completely with each other.

The spatial light modulator 31, as shown in FIG. 4, is a movable multi-mirror including the mirror elements 31a which are a large number of microscopic reflecting elements arrayed regularly and two-dimensionally along a plane in a state in which their reflecting faces of a planar shape are top faces. Each mirror element 31a is movable and an inclination of the reflecting face thereof, i.e., an inclination angle and inclination direction of the reflecting face, is independently controlled by action of the drive unit 31c operating in accordance with a command from the control unit CR. Each mirror element 31a can be continuously or discretely rotated by a desired rotation angle around axes of rotation along two directions parallel to its reflecting face and orthogonal to each other (e.g., the X-direction and Y-direction). Namely, the inclination of the reflecting face of each mirror element 31a can be controlled two-dimensionally.

When the reflecting faces of the respective mirror elements 31a are discretely rotated, a preferred control method is to switch the rotation angle among a plurality of states (e.g., . . . , −2.5°, −2.0°, . . . 0°, +0.5° . . . +2.5°, . . . ). FIG. 4 shows the mirror elements 31a with the contour of a square shape, but the contour of the mirror elements 31a is not limited to the square shape. However, in terms of light utilization efficiency, the contour can be a shape allowing an array with little clearance between the mirror elements 31a (a shape permitting closest packing). Furthermore, in terms of light utilization efficiency, the clearance between two adjacent mirror elements 31a can be controlled to the minimum necessary.

The present embodiment adopts, for example, a spatial light modulator configured to continuously vary each of orientations of the mirror elements 31a arrayed two-dimensionally, as the spatial light modulator 31. The spatial light modulator of this type can be one selected, for example, from those disclosed in European Patent Application Laid-Open No. 779530 (corresponding to Japanese Translation of PCT Application Laid-Open No. 10-503300), U.S. Pat. No. 6,900,915 (corresponding to Japanese Patent Application Laid-Open No. 2004-78136), U.S. Pat. No. 7,095,546 (corresponding to Japanese Translation of PCT Application Laid-Open No. 2006-524349), Japanese Patent Application Laid-Open No. 2006-113437. It is also possible to control the orientations of the two-dimensionally arrayed mirror elements 31a discretely in a plurality of conditions.

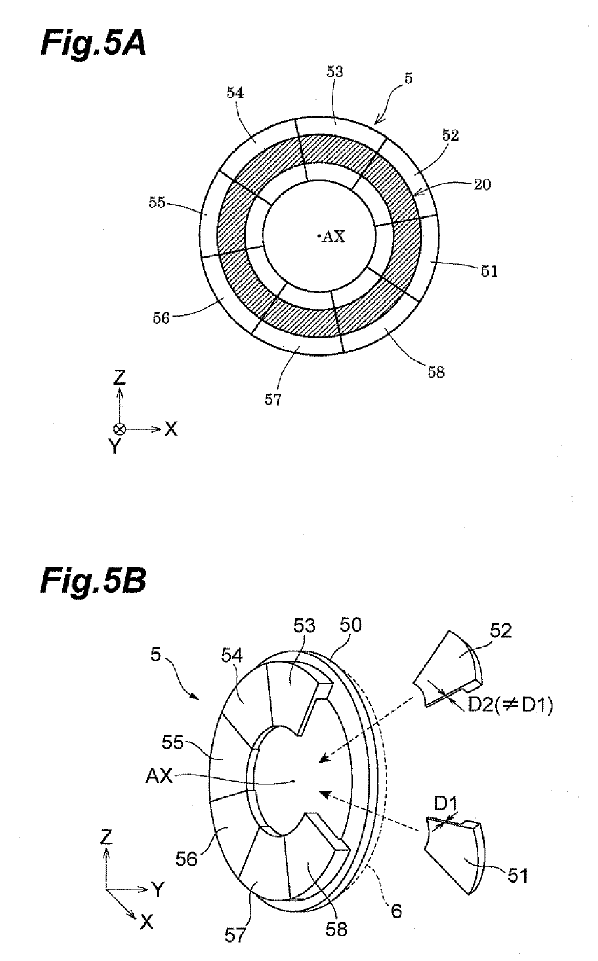

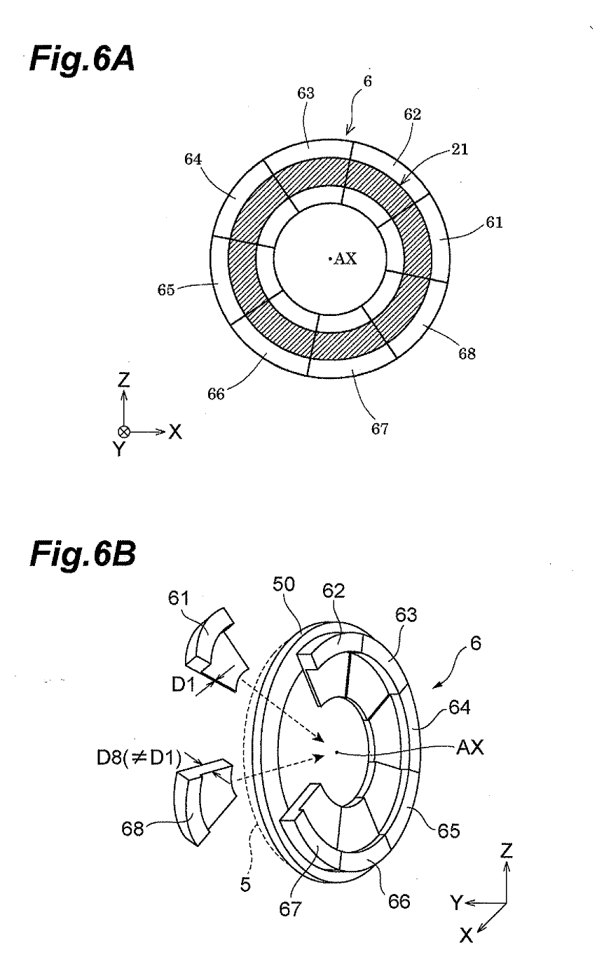

In the spatial light modulator 31, 32, the postures of the respective mirror elements 31a, 32a each are varied so that the mirror elements 31a, 32a are set in respective predetermined orientations, by action of the drive unit 31c, 32c (32e not shown) operating in accordance with a control signal from the control unit CR. Rays reflected at respective predetermined angles by the mirror elements 31a, 32a of the spatial light modulator 31, 32 form, for example, an annular light intensity distribution (hatched portion in FIG. 5A) 20 centered on the optical axis AX, on the entrance plane of the first polarization converting member 5 in the polarization converting unit TU, as shown in FIG. 5A. As shown in FIG. 6A, an annular light intensity distribution (hatched portion in FIG. 6A) 21 corresponding to the light intensity distribution 20 is formed on the entrance plane of the second polarization converting member 6 arranged next to and immediately after the first polarization converting member 5.

With reference to FIG. 5A, the first polarization converting member 5 has eight optically rotatory members 51, 52, 53, 54, 55, 56, 57, and 58 of a plane-parallel plate shape arrayed along the circumferential direction around the optical axis AX. The “circumferential direction around the optical axis AX” means a direction corresponding to a circumferential direction or rotational direction of an imaginary circle centered on the optical axis AX, on a plane perpendicular to the optical axis AX, and will also be used in the same meaning in the description hereinafter. Each optically rotatory member 51-58 is made of a crystal material being an optical material with an optical rotatory power, e.g., quartz crystal. When the first polarization converting member 5 is positioned in the optical path, the entrance plane (and the exit plane eventually) of each optically rotatory member 51-58 is perpendicular to the optical axis AX and its crystal optic axis is approximately coincident with the direction of the optical axis AX (i.e., approximately coincident with the Y-direction which is the traveling direction of incident light).

The eight optically rotatory members 51-58 constituting the first polarization converting member 5 occupy eight divided regions obtained by dividing an annular region centered on the optical axis AX (which is defined on the plane perpendicular to the optical axis AX and which will also apply to the description hereinafter) into eight equal regions along the circumferential direction of the annular region. In other words, the eight optically rotatory members 51-58 are separated in such a manner that eight arcuate beams obtained by equally dividing the annular beam 20 corresponding to the incident light into eight beams along the circumferential direction pass through the respective members. Two adjacent optically rotatory members out of the eight optically rotatory members 51-58 have mutually different thicknesses and therefore have mutually different polarization conversion properties. The first polarization converting member 5 composed of the optically rotatory members 51-58 with their respective thicknesses different from each other has a thickness distribution (first thickness distribution) varying in the circumferential direction of the first polarization converting member 5, as a whole.

The above-described configuration can be substantialized by fixing one-side ends of the respective optically rotatory members 51-58 to one surface of a reinforcing member 50 of a ring shape, as shown in FIG. 5B. A part of the second polarization converting member 6 is fixed to the other surface of the reinforcing member 50. Light transmitting portions of the optically rotatory members 51-58 are processed so as to have their respective desired thicknesses. Concerning thicknesses of two optically rotatory members selected from those 51-58, e.g., in the case of the optically rotatory member 51 and the optically rotatory member 52 with respective thicknesses adjacent to each other, the thickness of the light transmitting portion of the optically rotatory member 51 is set to D1, while the thickness of the light transmitting portion of the optically rotatory member 52 is set to D2 (≠D1).

Specifically, the thickness D1 of the optically rotatory member 51 is set as follows: when Z-directionally linearly polarized light having the direction of polarization along the Z-direction is incident thereto, it outputs Z-directionally linearly polarized light without change in the polarization direction thereof (i.e., with 0° or 180° rotation of the polarization direction thereof). The optically rotatory member 51 is positioned so that a center line extending in a radial direction of a circle about the optical axis AX while passing a center along the circumferential direction thereof is parallel (or coincident) with a line segment obtained by rotating a line segment extending in the +X-direction from the optical axis AX, by 11.25° clockwise in FIG. 5A. The thickness D2 of the optically rotatory member 52 adjacent to the optically rotatory member 51 along the circumferential direction counterclockwise in FIG. 5A is set as follows: when the Z-directionally linearly polarized light is incident thereto, it outputs linearly polarized light having the polarization direction along a direction resulting from +22.5° (22.5° counterclockwise in FIG. 5A) rotation of the Z-direction.

The thickness D3 of the optically rotatory member 53 adjacent to the optically rotatory member 52 is set as follows: when the Z-directionally linearly polarized light is incident thereto, it outputs linearly polarized light having the polarization direction along a direction resulting from +45° rotation of the Z-direction. The thickness D4 of the optically rotatory member 54 adjacent to the optically rotatory member 53 is set as follows: when the Z-directionally linearly polarized light is incident thereto, it outputs linearly polarized light having the polarization direction along a direction resulting from +67.5° rotation of the Z-direction. The thickness D5 of the optically rotatory member 55 adjacent to the optically rotatory member 54, i.e., the optically rotatory member 55 opposite to the optically rotatory member 51 with respect to the optical axis AX is set as follows: when the Z-directionally linearly polarized light is incident thereto, it outputs X-directionally linearly polarized light having the polarization direction along the X-direction resulting from +90° rotation of the Z-direction.

The thickness D6 of the optically rotatory member 56 adjacent to the optically rotatory member 55 is set as follows: when the Z-directionally linearly polarized light is incident thereto, it outputs linearly polarized light having the polarization direction along a direction resulting from −67.5° (or +112.5°: i.e., 67.5° clockwise in FIG. 5A) rotation of the Z-direction. The thickness D7 of the optically rotatory member 57 adjacent to the optically rotatory member 56 is set as follows: when the Z-directionally linearly polarized light is incident thereto, it outputs linearly polarized light having the polarization direction along a direction resulting from −45° (or)+135° rotation of the Z-direction. The thickness D8 of the optically rotatory member 58 adjacent to the optically rotatory member 57 and the optically rotatory member 51 is set as follows: when the Z-directionally linearly polarized light is incident thereto, it outputs linearly polarized light having the polarization direction along a direction resulting from −22.5° (or)+157.5° rotation of the Z-direction. It is assumed in the description hereinafter that the Z-directionally linearly polarized light is incident to the first polarization converting member 5 (and therefore to the polarization converting unit TU).

The second polarization converting member 6, as shown in FIG. 6A, has eight optically rotatory members 61, 62, 63, 64, 65, 66, 67, and 68 of a plane-parallel plate shape arrayed along the circumferential direction of a circle centered on the optical axis AX. Each optically rotatory member 61-68 is made of a crystal material being an optical material with an optical rotatory power, e.g., quartz crystal. When the second polarization converting member 6 is positioned in the optical path, the entrance plane (and the exit plane eventually) of each optically rotatory member 61-68 is perpendicular to the optical axis AX and its crystal optic axis is approximately coincident with the direction of the optical axis AX.

The eight optically rotatory members 61-68 occupy eight divided regions obtained by dividing an annular region centered on the optical axis AX, into eight equal regions along the circumferential direction of the annular region. In other words, the eight optically rotatory members 61-68 are separated in such a manner that eight arcuate beams obtained by equally dividing the annular beam 21 corresponding to the incident light, into eight beams along the circumferential direction pass through the respective members. Two adjacent optically rotatory members out of the eight optically rotatory members 61-68 have mutually different thicknesses and therefore mutually different polarization conversion properties. The second polarization converting member 6 composed of the optically rotatory members 61-68 with the mutually different thicknesses has a thickness distribution (second thickness distribution) varying in the circumferential direction of the second polarization converting member 6, as a whole. In the present embodiment the first thickness distribution and the second thickness distribution are the same distributions, but are positioned in such correspondence as to have different azimuth angles around the optical axis.

The above-described configuration can be substantialized by fixing one-side ends of the respective optically rotatory members 61-68 to the other surface of the reinforcing member 50 of the ring shape, as shown in FIG. 6B. A part of the first polarization converting member 5 is fixed to one surface of the reinforcing member 50 as described above. Light transmitting portions of the optically rotatory members 61-68 are processed so as to have their respective desired thicknesses. Concerning thicknesses of two optically rotatory members selected from those 61-68, e.g., in the case of the optically rotatory member 68 and the optically rotatory member 61 with respective thicknesses adjacent to each other, the thickness of the light transmitting portion of the optically rotatory member 68 is set to D8, while the thickness of the light transmitting portion of the optically rotatory member 61 is set to D1 (≠D8).

Specifically, the thickness D1 of the optically rotatory member 61 is set as follows: when the Z-directionally linearly polarized light is incident thereto, it outputs Z-directionally linearly polarized light without change in the polarization direction thereof (i.e., with 0° or 180° rotation of the polarization direction thereof). The optically rotatory member 61 is positioned so that a boundary line to the optically rotatory member 68 adjacent to the optically rotatory member 61 along the circumferential direction clockwise in FIG. 6A is correspondent to the center line of the optically rotatory member 51 extending in the radial direction. The thickness D2 of the optically rotatory member 62 adjacent to the optically rotatory member 61 along the circumferential direction counterclockwise in FIG. 6A is set as follows: when the Z-directionally linearly polarized light is incident thereto, it outputs linearly polarized light having the polarization direction along a direction resulting from +22.5° (22.5° counterclockwise in FIG. 6A) rotation of the Z-direction.

The thickness D3 of the optically rotatory member 63 adjacent to the optically rotatory member 62 is set as follows: when the Z-directionally linearly polarized light is incident thereto, it outputs linearly polarized light having the polarization direction along a direction resulting from +45° rotation of the Z-direction. The thickness D4 of the optically rotatory member 64 adjacent to the optically rotatory member 63 is set as follows: when the Z—directionally linearly polarized light is incident thereto, it outputs linearly polarized light having the polarization direction along a direction resulting from +67.5° rotation of the Z-direction. The thickness D5 of the optically rotatory member 65 adjacent to the optically rotatory member 64 is set as follows: when the Z-directionally linearly polarized light is incident thereto, it outputs X-directionally linearly polarized light having the polarization direction along the X-direction resulting from +90° rotation of the Z-direction.

The thickness D6 of the optically rotatory member 66 adjacent to the optically rotatory member 65 is set as follows: when the Z-directionally linearly polarized light is incident thereto, it outputs linearly polarized light having the polarization direction along a direction resulting from −67.5° (or +112.5°: i.e., 67.5° clockwise in FIG. 6A) rotation of the Z-direction. The thickness D7 of the optically rotatory member 67 adjacent to the optically rotatory member 66 is set as follows: when the Z-directionally linearly polarized light is incident thereto, it outputs linearly polarized light having the polarization direction along a direction resulting from −45° (or)+135° rotation of the Z-direction. The thickness D8 of the optically rotatory member 68 adjacent to the optically rotatory member 67 and the optically rotatory member 61 is set as follows: when the Z-directionally linearly polarized light is incident thereto, it outputs linearly polarized light having the polarization direction along a direction resulting from −22.5° (or)+157.5° rotation of the Z-direction.

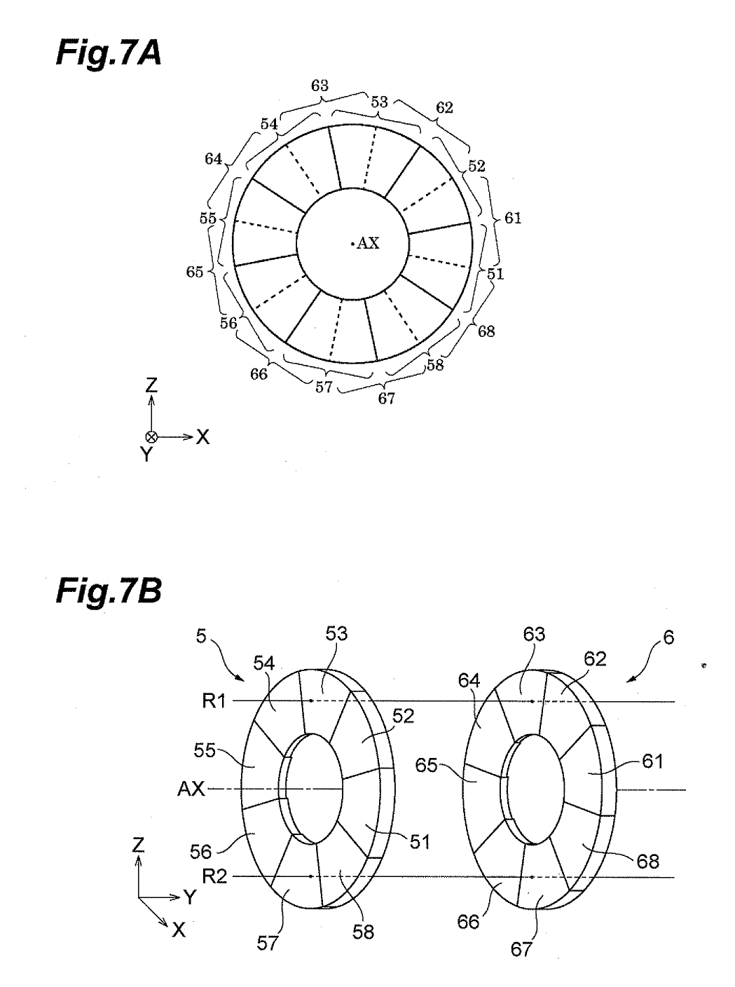

As described above, the second polarization converting member 6 has basically the same configuration as the first polarization converting member 5 and is arranged in a posture resulting from 11.25° rotation of the first polarization converting member 5 counterclockwise in FIG. 5A around the optical axis AX. As a result, as shown in FIG. 7A, when the pair of polarization converting members 5, 6 are viewed along the optical axis AX from the relay optical system 4 side, a boundary line between two adjacent optically rotatory members out of the eight optically rotatory members 51-58 in the first polarization converting member 5 is correspondent to a center line of a corresponding optically rotatory member out of the eight optically rotatory members 61-68 in the second polarization converting member 6, which extends in a radial direction of a circle centered on the optical axis AX while passing a center of an arc along the circumferential direction (which is a radial direction of an imaginary circle defined on a plane perpendicular to the optical axis AX and centered on the optical axis AX and which will also apply to the description hereinafter).

In another expression, a radially extending center line of one optically rotatory member out of the eight optically rotatory members 51-58 in the first polarization converting member 5 is correspondent to a boundary line between two corresponding adjacent optically rotatory members out of the eight optically rotatory members 61-68 in the second polarization converting member 6. Specifically, the center line of the optically rotatory member 51 extending in the foregoing radial direction is correspondent to the boundary line (indicated by a dashed line in FIG. 7A) between the optically rotatory member 61 and the optically rotatory member 68. The center line of the optically rotatory member 52 extending in the foregoing radial direction is correspondent to the boundary line between the optically rotatory member 61 and the optically rotatory member 62. The above-described positional relationship between the center line and the boundary line also applies similarly to the other optically rotatory members 53-58.

Therefore, when attention is focused on a beam set in a predetermined linearly polarized state through the optically rotatory member 51, half of this beam is incident to the optically rotatory member 61 while the rest half is incident to the optically rotatory member 68. Since the optically rotatory members 61 and 68 have mutually different polarization conversion properties, the polarization state of the beam having passed through the optically rotatory members 51 and 61 becomes different from that of the beam having passed through the optically rotatory members 51 and 68. Similarly, the polarization state of the beam having passed through the optically rotatory members 52 and 61 is different from that of the beam having passed through the optically rotatory members 52 and 62.

In this manner, though description is omitted about the beams having passed through the other optically rotatory members 53-58, two beams in mutually different polarization states are generated immediately after passage through one optically rotatory member in the first polarization converting member 5 and two corresponding adjacent optically rotatory members in the second polarization converting member 6. Namely, corresponding to the eight optically rotatory members of the first polarization converting member 5, sixteen (=8×2) beams in which the polarization states of two adjacent beams are different from each other are generated immediately after the second polarization converting member 6 (therefore, immediately after the polarization converting unit TU).

In the present embodiment, the first polarization converting member 5 is configured as follows: the eight optically rotatory members 51-58 in which two adjacent optically rotatory members have mutually different polarization conversion properties are arrayed at the angle pitch of 45° along the circumferential direction of the circle centered on the optical axis AX. Similarly, the second polarization converting member 6 is configured as follows: the eight optically rotatory members 61-68 with the respective polarization conversion properties corresponding to the respective optically rotatory members 51-58 are arrayed at the angle pitch of 45° along the circumferential direction of the circle centered on the optical axis AX. Namely, two adjacent optically rotatory members out of the eight optically rotatory members 61-68 have mutually different polarization conversion properties.

However, a corresponding pair of optically rotatory members, e.g., the optically rotatory members 51 and 61 in the first polarization converting member 5 and the second polarization converting member 6 are arranged with an angular deviation in the circumferential direction around the optical axis AX being equal to half of the angle pitch of 45°. As a result, the first polarization converting member 5 and the second polarization converting member 6 are arranged so that a beam having passed through one optically rotatory member of the first polarization converting member 5 is incident to two corresponding adjacent optically rotatory members of the second polarization converting member 6.

The polarization states of the beams passing through the first and second polarization converting members 5, 6 arranged as described above are different depending upon their passing positions. Specifically, as shown in FIG. 7B, the sum (D3+D3) of the respective thicknesses of the optically rotatory member 53 and the optically rotatory member 63 through which a first reference axis R1 parallel to the optical axis AX passes is different from the sum (D7+D6) of the respective thicknesses of the optically rotatory member 57 and the optically rotatory member 66 through which a second reference axis R2 different from the first reference axis R1 passes. This means that total propagation distances of the beams in the optically rotatory members are different depending upon their passing positions and this enables the passing beams to be given different polarization states depending upon passing positions.

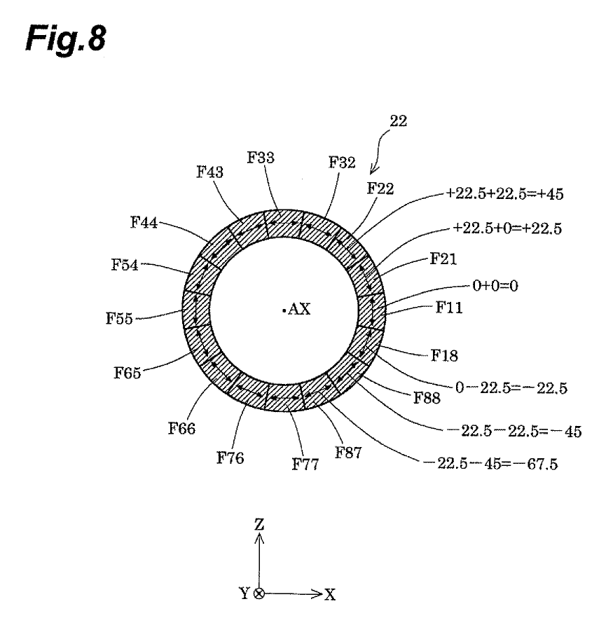

The polarization conversion properties of the respective optically rotatory members 51-58 in the first polarization converting member 5 (and therefore the polarization conversion properties of the respective optically rotatory members 61-68 in the second polarization converting member 6) are set as described with reference to FIGS. 5A, 5B and 6A, 6B. As a result, an annular light intensity distribution 22 centered on the optical axis AX is formed on the illumination pupil immediately after the second polarization converting member 6, as shown in FIG. 8, to achieve a circumferentially polarized state with high continuity in which the polarization states of the beams passing through the respective divided regions as sixteen equally divided regions in the circumferential direction of the annular light intensity distribution 22 are set in the circumferential direction.

First, when attention is focused on an arcuate beam having passed through the optically rotatory member 51 in the first polarization converting member 5, a beam F11 generated through the optically rotatory member 61 in the second polarization converting member 6 is linearly polarized light having the polarization direction along a direction resulting from 0° (or 180°) rotation of the Z-direction. Here, 0° as a composite rotation angle by the optically rotatory members 51 and 61 is nothing but the sum of 0° as the rotation angle by the optically rotatory member 51 and 0° as the rotation angle by the optically rotatory member 61. On the other hand, a beam F18 generated through the optically rotatory member 51 and the optically rotatory member 68 is linearly polarized light having the polarization direction along a direction resulting from −22.5° (22.5° clockwise in FIG. 8) rotation of the Z-direction. Here, −22.5° as a composite rotation angle by the optically rotatory members 51 and 68 is obtained as the sum of 0° as the rotation angle by the optically rotatory member 51 and −22.5° as the rotation angle by the optically rotatory member 68.

When attention is focused on an arcuate beam having passed through the optically rotatory member 52 in the first polarization converting member 5, a beam F21 generated through the optically rotatory member 61 in the second polarization converting member 6 is linearly polarized light having the polarization direction along a direction resulting from +22.5° (=+22.5+0: 22.5° counterclockwise in FIG. 8) rotation of the Z-direction. On the other hand, a beam F22 generated through the optically rotatory member 52 and the optically rotatory member 62 is linearly polarized light having the polarization direction along a direction resulting from +45° (=+22.5+22.5) rotation of the Z-direction.

When attention is focused on an arcuate beam having passed through the optically rotatory member 58 in the first polarization converting member 5, a beam F88 generated through the optically rotatory member 68 in the second polarization converting member 6 is linearly polarized light having the polarization direction along a direction resulting from −45° (=−22.5−22.5) rotation of the Z-direction. On the other hand, a beam F87 generated through the optically rotatory member 58 and the optically rotatory member 67 is linearly polarized light having the polarization direction along a direction resulting from −67.5° (=−22.5 −45) rotation of the Z-direction.

In this manner, though the description is omitted as to the arcuate beams having passed through the other optically rotatory members 53-57 in the first polarization converting member 5, the annular light intensity distribution 22 is formed in the circumferentially polarized state with high continuity of the sixteen-equal-division type on the illumination pupil immediately after the second polarization converting member 6. In the circumferentially polarized state, a beam passing through the annular light intensity distribution 22 becomes linearly polarized light having the polarization direction along a tangent direction to an imaginary circle defined on a plane perpendicular to the optical axis AX and centered on the optical axis AX. As a result, an annular light intensity distribution is formed in a substantially continuous, circumferentially polarized state corresponding to the annular light intensity distribution 22, on the illumination pupil immediately after the micro fly's eye lens 8. Furthermore, an annular light intensity distribution is also formed in a substantially continuous, circumferentially polarized state corresponding to the annular light intensity distribution 22, at positions of other illumination pupils optically conjugate with the illumination pupil immediately after the micro fly's eye lens 8, i.e., at the pupil position of the imaging optical system 11 and at the pupil position of the projection optical system PL (position where the aperture stop AS is located).

In general, in the case of circumferential polarization illumination based on the pupil intensity distribution of the annular shape or multi-polar shape (dipolar, quadrupolar, octupolar, or other shape) in the circumferentially polarized state, the light impinging upon the wafer W as a final illumination target surface is in a polarized state in which the major component is S-polarized light. The S-polarized light herein is linearly polarized light having the polarization direction along a direction perpendicular to a plane of incidence (polarized light whose electric vector is vibrating in the direction perpendicular to the plane of incidence). It is noted herein that the plane of incidence is a plane defined as follows: when light arrives at a boundary surface (illumination target surface: surface of the wafer W) of a medium, a plane including a normal to the boundary plane at that point and a direction of incidence of the light is defined as the plane of incidence. As a result, the circumferential polarization illumination permits improvement in optical performance (depth of focus and others) of the projection optical system and provides a mask pattern image with high contrast on the wafer (photosensitive substrate).

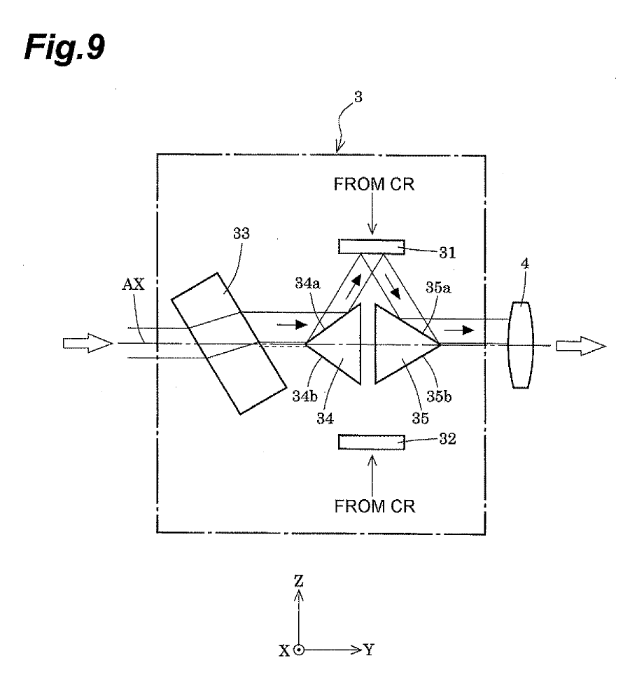

In the present embodiment, when the plane-parallel plate 33 is switched from the first posture to the second posture (corresponding to the posture indicated by dashed line 33b in FIG. 2) as shown in FIG. 9, the parallel beam incident along the optical axis AX to the spatial light modulating unit 3 is subjected to the respective refraction actions of the entrance plane and the exit plane of the plane-parallel plate 33, to be guided to the first reflecting surface 34a of the deflecting member 34. The light reflected by the first reflecting surface 34a is modulated by the first spatial light modulator 31, is reflected by the first reflecting surface 35a of the deflecting member 35, and then is guided to the relay optical system 4.

Namely, when the tillable plane-parallel plate 33 is set in the second posture, the light from the light source 1 is guided to the first spatial light modulator 31 by cooperation of the plane-parallel plate 33 and the deflecting member 34, but is not guided to the second spatial light modulator 32. In this manner, the light having traveled via the first spatial light modulator 31 forms, for example, an annular light intensity distribution corresponding to the annular light intensity distribution 22, on the illumination pupil at or near the rear focal plane of the micro fly's eye lens 8.

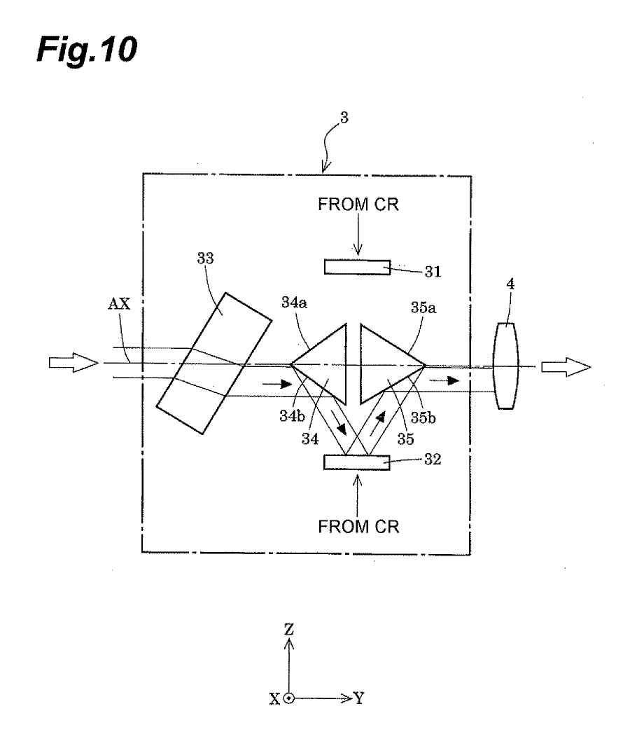

When the plane-parallel plate 33 is switched from the first posture to the third posture (corresponding to the posture indicated by dashed line 33c in FIG. 2) as shown in FIG. 10, the parallel beam incident along the optical axis AX to the spatial light modulating unit 3 is subjected to the respective refraction actions of the entrance plane and the exit plane of the plane-parallel plate 33, to be guided to the second reflecting surface 34b of the deflecting member 34. The light reflected by the second reflecting surface 34b is modulated by the second spatial light modulator 32, is reflected by the second reflecting surface 35b of the deflecting member 35, and then is guided to the relay optical system 4.

Namely, when the tillable plane-parallel plate 33 is set in the third posture, the light from the light source 1 is guided to the second spatial light modulator 32 by cooperation of the plane-parallel plate 33 and the deflecting member 34, but is not guided to the first spatial light modulator 31. In this manner, the light having traveled via the second spatial light modulator 32 forms, for example, an annular light intensity distribution corresponding to the annular light intensity distribution 22, on the illumination pupil at or near the rear focal plane of the micro fly's eye lens 8.

With the polarization converting unit TU of the present embodiment, as described above, the annular light intensity distribution 22 is formed in the substantially continuous, circumferentially polarized state of the sixteen-equal-division type (in general, the sixteen-division type) on the illumination pupil immediately after the second polarization converting member 6, by the composite optical rotatory action of one optically rotatory member out of the eight optically rotatory members 51-58 in the first polarization converting member 5 and two corresponding adjacent optically rotatory members out of the eight optically rotatory members 61-68 in the second polarization converting member 6, i.e., by the composite optical rotatory action of the paired optically rotatory members consisting of sixteen ways of combinations of the eight front optically rotatory members and two rear optically rotatory members corresponding to each front optically rotatory member. As a result, the polarization converting unit TU of the present embodiment, when arranged in the optical path of the illumination optical system (2-11), is able to achieve the annular pupil intensity distribution in the circumferentially polarized state with high continuity.

The illumination optical system (2-11) of the present embodiment is able to illuminate the pattern surface (illumination target surface) of the mask M with the light in the desired circumferentially polarized state, using the polarization converting unit TU achieving the annular pupil intensity distribution in the circumferentially polarized state with high continuity. The exposure apparatus (2-WS) of the present embodiment is able to accurately transfer the microscopic pattern onto the wafer W while suitably fulfilling the operational advantage of circumferential polarization under an appropriate illumination condition achieved according to a characteristic of the pattern of the mask M to be transferred, using the illumination optical system (2-11) to illuminate the pattern surface of the mask M with the light in the desired circumferentially polarized state.

Incidentally, if the annular light intensity distribution 22 in the substantially continuous, circumferentially polarized state of the sixteen-division type is formed using a single polarization converting member having a configuration like the polarization converting member 5 or 6, sixteen optically rotatory members with slightly different polarization conversion properties between two adjacent optically rotatory members must be arrayed in the circumferential direction. However, the manufacture of the polarization converting member of the sixteen-division type is much more difficult than the manufacture of the polarization converting member 5 or 6 of the eight-division type. As described above, the present embodiment is advantageous in terms of the relatively easy manufacture of the polarization converting member while the number of divisions of the circumferential polarization state is relatively large.

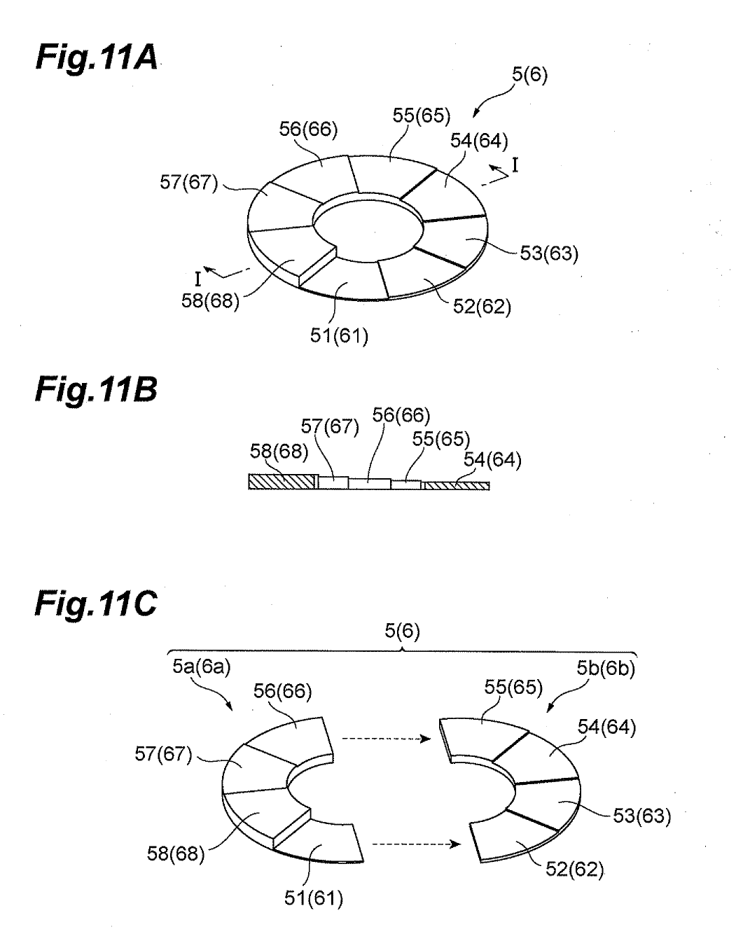

In the above embodiment, the first and second polarization converting members 5, 6 were constructed using the plurality of optically rotatory members 51-58, 61-68 (cf. FIGS. 5A, 5B and 6A, 6B). However, the first or second polarization converting member 5, 6 may be made by etching at least one surface of a plane-parallel plate made of an optical material with an optical rotatory power so as to have the first or second thickness distribution. At this time, the first or second polarization converting member 5, 6 may be formed by etching a single plane-parallel plate, as shown in FIG. 11A. FIG. 11B is a sectional view of the first or second polarization converting member 5, 6 along line I-I in FIG. 11A. Another example is to form the first or second polarization converting member 5, 6 by etching a plurality of plane-parallel plates, as shown in FIG. 11C. For example, in the example of FIG. 11C, a divided member 5a (6a) obtained by etching a single plane-parallel plate is formed as a portion corresponding to the optically rotatory members 51-54 (61-64), while a divided member 5b (6b) obtained by etching another single plane-parallel plate is formed as a portion corresponding to the optically rotatory members 55-58 (65-68). Then these divided members 5a (6a) and 5b (6b) are combined to construct the first or second polarization converting member 5, 6.

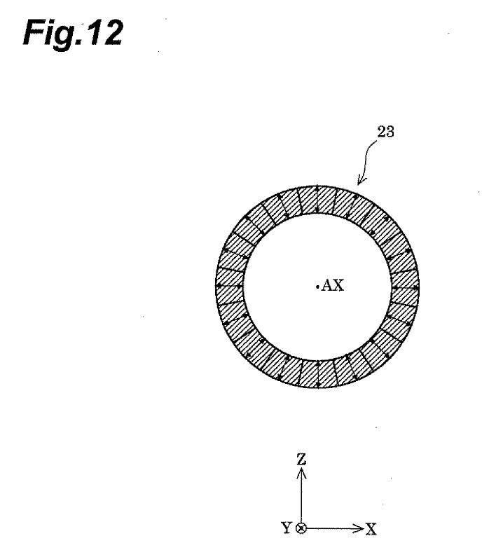

In the above-described embodiment the Z-directionally linearly polarized light is made incident to the first polarization converting member 5, whereas in a case where X-directionally linearly polarized light is made incident to the first polarization converting member 5, an annular light intensity distribution 23 in a radially polarized state with high continuity of the sixteen-equal-division type is formed on the illumination pupil immediately after the second polarization converting member 6, as shown in FIG. 12. In the radially polarized state, the beam passing through the annular light intensity distribution 23 is linearly polarized light having the polarization directions along the radial directions of the circle centered on the optical axis AX.

In general, in the case of the radial polarization illumination based on the annular or multi-polar pupil intensity distribution in the radially polarized state, the light impinging upon the wafer W as a final illumination target surface is in a polarization state in which the major component is P-polarized light. The P-polarized light herein is linearly polarized light having the polarization direction along a direction parallel to the plane of incidence defined as described above (i.e., polarized light whose electric vector is vibrating in the direction parallel to the plane of incidence). As a result, the radial polarization illumination provides a good mask pattern image on the wafer (photosensitive substrate) while keeping the reflectance of light small on a resist applied on the wafer W.

The above embodiment described the present invention on the basis of the spatial light modulating unit 3 having the specific configuration shown in FIG. 2, but various forms can be contemplated as to the configuration of the spatial light modulating unit. Specifically, the foregoing embodiment uses the pair of reflection type spatial light modulators 31, 32 arranged in parallel in the optical path, as the spatial light modulating elements for imparting spatial modulation to incident light and emitting spatially modulated light, and the plane-parallel plate 33 as halving is located on the light source side of the spatial light modulators.

However, without having to be limited to this configuration, various forms can be contemplated as to the type and number of spatial light modulating elements, the configuration of halving (beam moving part), the presence/absence of installation of halving, and so on. For example, the spatial light modulating elements applicable herein can be transmission type spatial light modulators each having a plurality of transmissive optical elements arrayed two-dimensionally and controlled individually, transmission type diffractive optical elements, reflection type diffractive optical elements, and so on. It is also possible to construct the beam moving part of a pair of mirrors.

In the above embodiment, the first polarization converting member 5 and the second polarization converting member 6 are arranged adjacent to each other. However, without having to be limited to this, it is also possible to adopt a configuration provided with a relay optical system for making the first polarization converting member and the second polarization converting member optically conjugate with each other. For example, in the configuration shown in FIG. 1A, it is also possible to adopt a form wherein the second polarization converting member 6 is moved from the position immediately after the first polarization converting member 5 to a position near the entrance plane of the micro fly's eye lens 8 (cf. FIG. 1B). In this case, the relay optical system 7 makes the first polarization converting member 5 and the second polarization converting member 6 optically conjugate with each other.

In the above embodiment, the polarization converting members 5, 6 have the annular contour as a whole and are composed of the eight arcuate optically rotatory members 51-58; 61-68. However, without having to be limited to this, various forms can be contemplated as to the overall contour of each polarization converting member, the type, shape, and number of fundamental elements constituting each polarization converting member, and so on. For example, it is also possible to construct the polarization converting member with a circular contour as a whole, of a plurality of optically rotatory members of a fan shape.

In general, it is possible to construct the first polarization converting member of a plurality of wave plates to convert incident light into light in a predetermined polarization state or to construct the first polarization converting member of a plurality of polarizers to select and emit light in a predetermined polarization state from incident light. When the first polarization converting member is constructed of a plurality of polarizers, for example, light in an unpolarized state is made incident thereto. It is also possible to construct the second polarization converting member of a plurality of wave plates to convert incident light into light in a predetermined polarization state.

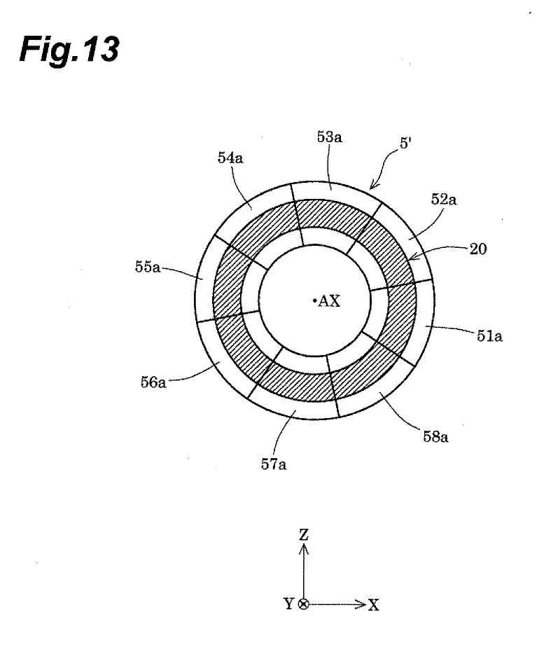

The below will describe a modification example wherein the first polarization converting member and the second polarization converting member are constructed of the wave plates, with reference to FIGS. 13 to 15. The first polarization converting member 5′, as shown in FIG. 13, has eight half wave plates 51a, 52a, 53a, 54a, 55a, 56a, 57a, and 58a arrayed along the circumferential direction around the optical axis AX. It is assumed hereinafter for simplicity of description that the eight wave plates 51a-58a in the modification example have the same contour as the eight optically rotatory members 51-58 in the first polarization converting member 5 in the above embodiment and are arranged according to the same array as the eight optically rotatory members 51-58.

In the first polarization converting member 5′, the wave plate 51a is set so that its optic axis is directed along the Z-direction resulting from 0° rotation of the Z—direction. The wave plate 52a is set so that its optic axis is directed along a direction resulting from −11.25° (11.25° clockwise in FIG. 13) rotation of the Z-direction. The wave plate 53a is set so that its optic axis is directed along a direction resulting from −22.5° rotation of the Z-direction. The wave plate 54a is set so that its optic axis is directed along a direction resulting from −33.75° rotation of the Z-direction.

The wave plate 55a is set so that its optic axis is directed along a direction resulting from −45° rotation of the Z-direction. The wave plate 56a is set so that its optic axis is directed along a direction resulting from −56.25° rotation of the Z-direction. The wave plate 57a is set so that its optic axis is directed along a direction resulting from −67.5° rotation of the Z-direction. The wave plate 58a is set so that its optic axis is directed along a direction resulting from −78.75° rotation of the Z-direction.

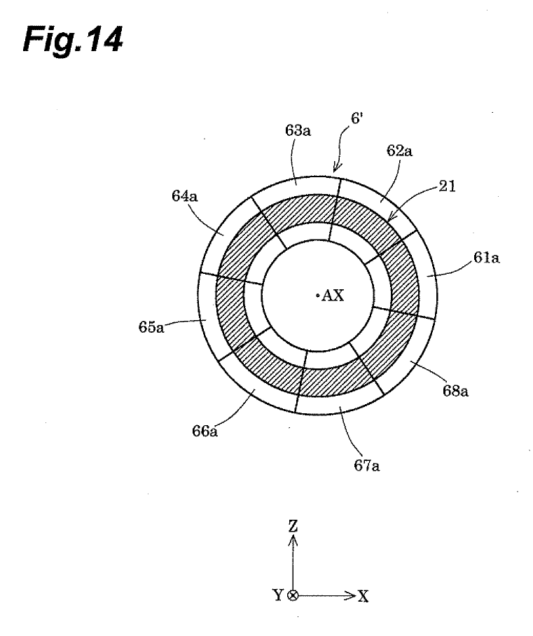

The second polarization converting member 6′, as shown in FIG. 14, has eight half wave plates 61a, 62a, 63a, 64a, 65a, 66a, 67a, and 68a arrayed along the circumferential direction around the optical axis AX. The eight wave plates 61a-68a in the modification example have the same contour as the eight optically rotatory members 61-68 in the second polarization converting member 6 in the above embodiment and are arranged according to the same array as the eight optically rotatory members 61-68.

In the second polarization converting member 6′, the wave plate 61a is set so that its optic axis is directed along the X-direction resulting from 90° rotation of the Z-direction. The wave plate 62a is set so that its optic axis is directed along a direction resulting from +11.25° (11.25° counterclockwise in FIG. 14) rotation of the Z-direction. The wave plate 63a is set so that its optic axis is directed along a direction resulting from +22.5° rotation of the Z-direction. The wave plate 64a is set so that its optic axis is directed along a direction resulting from +33.75° rotation of the Z-direction.

The wave plate 65a is set so that its optic axis is directed along a direction resulting from +45° rotation of the Z-direction. The wave plate 66a is set so that its optic axis is directed along a direction resulting from +56.25° rotation of the Z-direction. The wave plate 67a is set so that its optic axis is directed along a direction resulting from +67.5° rotation of the Z-direction. The wave plate 68a is set so that its optic axis is directed along a direction resulting from +78.75° rotation of the Z-direction.

In the modification example in FIGS. 13 and 14, when the beam of Z-directionally polarized light is made incident to the first polarization converting member 5′, the annular light intensity distribution 22 is formed in the circumferentially polarized state with high continuity of the sixteen-equal-division type as shown in FIG. 8, on the illumination pupil immediately after the second polarization converting member 6′. When the beam of X-directionally linearly polarized light is made incident to the first polarization converting member 5′, the annular light intensity distribution 23 is formed in the radially polarized state with high continuity of the sixteen-equal-division type as shown in FIG. 12, on the illumination pupil immediately after the second polarization converting member 6′

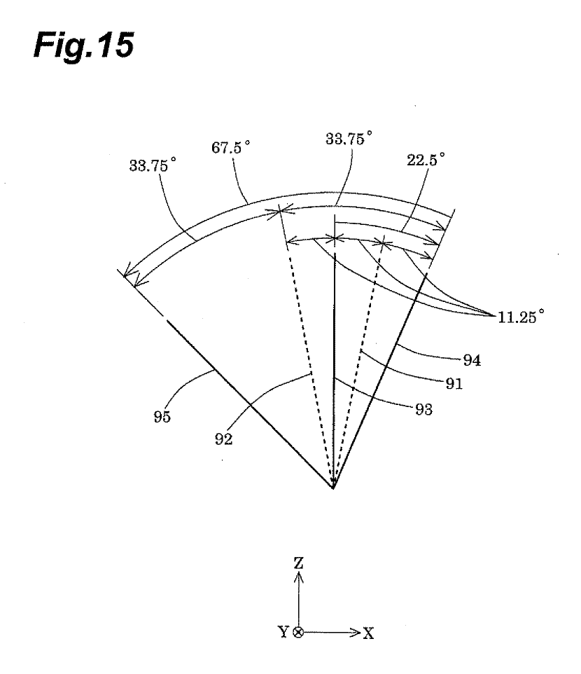

For example, when the beam of Z-directionally linearly polarized light is incident to the first polarization converting member 5′, a beam generated through the wave plate 52a and the wave plate 62a (corresponding to the beam F22 in FIG. 8) is linearly polarized light having the polarization direction along a direction resulting from +45° (45° counterclockwise in FIG. 8) rotation of the Z-direction. The composite polarization conversion action of the wave plate 52a and the wave plate 62a will be described with reference to FIG. 15. In FIG. 15, the optic axis of the wave plate 52a is indicated by dashed line 91 and the optic axis of the wave plate 62a by dashed line 92.

When the beam 93 of Z-directionally linearly polarized light is incident to the wave plate 52a, a beam 94 immediately after passage through the wave plate 52a is linearly polarized light having the polarization direction along a direction symmetric with the incident beam 93 with respect to the optic axis 91 of the wave plate 52a, i.e., along a direction resulting from −22.5° (22.5° clockwise in FIG. 15) rotation of the Z-direction. Thereafter, when the beam 94 of linearly polarized light is incident to the wave plate 62a, light 95 immediately after passage through the wave plate 62a (and therefore immediately after the second polarization converting member 6′) is linearly polarized light having the polarization direction along a direction symmetric with the incident beam 94 with respect to the optic axis 92 of the wave plate 62a, i.e., along a direction resulting from +45° (45° counterclockwise in FIG. 15) rotation of the Z-direction. The description is omitted herein as to the composite polarization conversion actions of the paired wave plates according to the other combinations.

The above description concerned the description of the operational advantage of the present invention using the modified illumination to form the annular pupil intensity distribution on the illumination pupil, i.e., the annular illumination as an example. However, without having to be limited to the annular illumination, it is apparent that the same operational advantage can also be achieved similarly by application of the present invention, for example, to multi-polar illumination to form a multi-polar pupil intensity distribution.

In the above description, the spatial light modulator in which the orientations (angles: inclinations) of the reflecting surfaces arrayed two-dimensionally can be individually controlled is used as each spatial light modulator having the plurality of optical elements arrayed two-dimensionally and controlled individually. However, without having to be limited to this, it is also possible, for example, to apply a spatial light modulator in which heights (positions) of the reflecting surfaces arrayed two-dimensionally can be individually controlled. Such a spatial light modulator applicable herein can be selected, for example, from those disclosed in U.S. Pat. No. 5,312,513 (corresponding to Japanese Patent Application Laid-Open No. 6-281869) and in FIG. 1d of U.S. Pat. No. 6,885,493 (corresponding to Japanese Translation of PCT Application Laid-Open No. 2004-520618). These spatial light modulators are able to apply the same action as a diffracting surface, to incident light by forming a two-dimensional height distribution. The aforementioned spatial light modulators having the plurality of reflecting surfaces arrayed two-dimensionally may be modified, for example, according to the disclosures in U.S. Pat. No. 6,891,655 (corresponding to Japanese Translation of PCT Application Laid-Open No. 2006-513442) and U.S. Patent Application Laid-Open No. 2005/0095749 (corresponding to Japanese Translation of PCT Application Laid-Open No. 2005-524112).

In the foregoing embodiment, the micro fly's eye lens 8 was used as an optical integrator, but an optical integrator of an internal reflection type (typically, a rod type integrator) may be used instead thereof. In this case, a condensing optical system for condensing the light from the polarization converting unit TU is arranged in place of the relay optical system 7. Furthermore, instead of the micro fly's eye lens 8 and the condenser optical system 9, the rod type integrator is arranged so that an entrance end thereof is positioned at or near the rear focus position of the condensing optical system for condensing the light from the polarization converting unit TU. At this time, an exit end of the rod type integrator is at the position of the mask blind 10. In the use of the rod type integrator, a position optically conjugate with the position of the aperture stop AS of the projection optical system PL, in the imaging optical system 11 downstream the rod type integrator can be called an illumination pupil plane. Since a virtual image of the secondary light source on the illumination pupil plane is formed at the position of the entrance plane of the rod type integrator, this position and positions optically conjugate therewith can also be called illumination pupil planes. The condensing optical system, the imaging optical system, and the rod type integrator can be regarded as a distribution forming optical system.

In the aforementioned embodiment, the mask can be replaced with a variable pattern forming device which forms a predetermined pattern on the basis of predetermined electronic data. The variable pattern forming device applicable herein can be, for example, a DMD (Digital Micromirror Device) including a plurality of reflective elements driven based on predetermined electronic data. The exposure apparatus with the DMD is disclosed, for example, in Japanese Patent Application Laid-Open No. 2004-304135 and U.S. Patent Application Laid-Open No. 2007/0296936 (corresponding to International Publication No. 2006/080285). Besides the reflection type spatial light modulators of the non-emission type like the DMD, it is also possible to apply transmission type spatial light modulators or self-emission type image display devices. The teachings of Japanese Patent Application Laid-Open No. 2004-304135 are incorporated herein by reference.

The exposure apparatus of the foregoing embodiment is manufactured by assembling various sub-systems containing their respective components as set forth in the scope of claims in the present application, so as to maintain predetermined mechanical accuracy, electrical accuracy, and optical accuracy. For ensuring these various accuracies, the following adjustments are carried out before and after the assembling: adjustment for achieving the optical accuracy for various optical systems; adjustment for achieving the mechanical accuracy for various mechanical systems; adjustment for achieving the electrical accuracy for various electrical systems. The assembling blocks from the various sub-systems into the exposure apparatus include mechanical connections, wire connections of electric circuits, pipe connections of pneumatic circuits, etc. between the various sub-systems. It is needless to mention that there are assembling blocks of the individual sub-systems, before the assembling blocks from the various sub-systems into the exposure apparatus. After completion of the assembling blocks from the various sub-systems into the exposure apparatus, overall adjustment is carried out to ensure various accuracies as the entire exposure apparatus. The manufacture of the exposure apparatus may be carried out in a clean room in which the temperature, cleanliness, etc. are controlled.

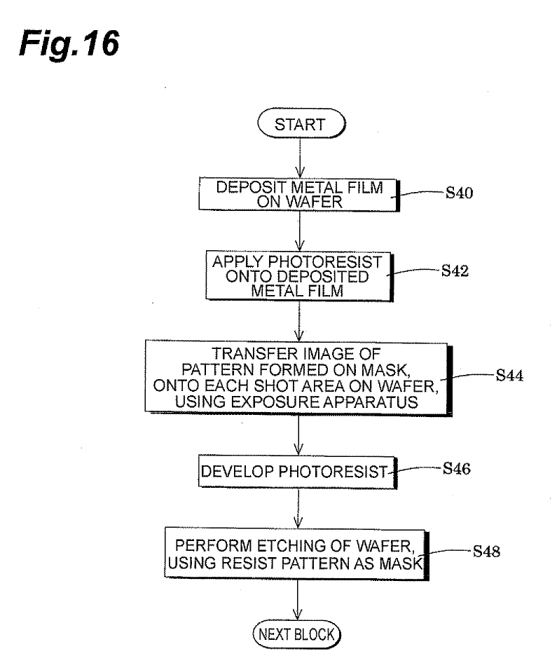

The following will describe a device manufacturing method using the exposure apparatus according to the above-described embodiment. FIG. 16 is a flowchart showing manufacturing blocks of semiconductor devices. As shown in FIG. 16, the manufacturing blocks of semiconductor devices include depositing a metal film on a wafer W to become a substrate of semiconductor devices (block S40) and applying a photoresist as a photosensitive material onto the deposited metal film (block S42). The subsequent blocks include transferring a pattern formed on a mask (reticle) M, onto each of shot areas on the wafer W, using the exposure apparatus of the above embodiment (block S44: exposure block), and developing the wafer W after completion of the transfer, i.e., developing the photoresist to which the pattern is transferred (block S46: development block).

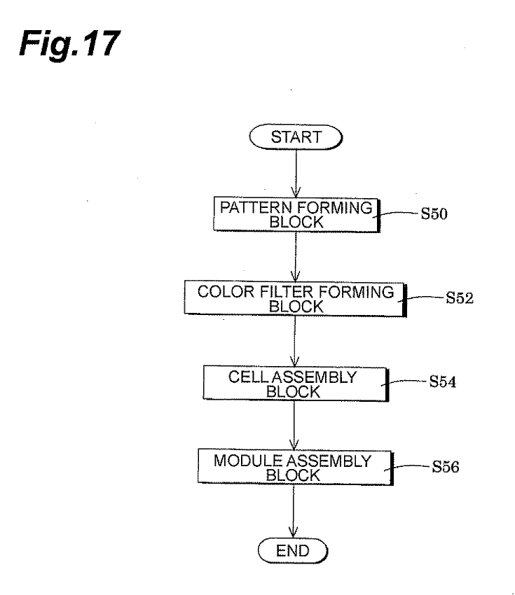

Thereafter, using the resist pattern made on the surface of the wafer W in block S46, as a mask, processing such as etching is carried out on the surface of the wafer W (block S48: processing block). The resist pattern herein is a photoresist layer in which depressions and projections are formed in a shape corresponding to the pattern transferred by the exposure apparatus of the above embodiment and which the depressions penetrate throughout. Block S48 is to process the surface of the wafer W through this resist pattern. The processing carried out in block S48 includes, for example, at least either etching of the surface of the wafer W or deposition of a metal film or the like. [0138] FIG. 17 is a flowchart showing manufacturing blocks of a liquid crystal device such as a liquid crystal display device. As shown in FIG. 17, the manufacturing blocks of the liquid crystal device include sequentially performing a pattern forming block (block S50), a color filter forming block (block S52), a cell assembly block (block S54), and a module assembly block (block S56). The pattern forming block of block S50 is to form predetermined patterns such as a circuit pattern and an electrode pattern on a glass substrate coated with a photoresist, as a plate P, using the projection exposure apparatus of the above embodiment. This pattern forming block includes an exposure block, a development block, and a processing block. The exposure block is to transfer a pattern to a photoresist layer, using the projection exposure apparatus of the above embodiment. The development block is to perform development of the plate P to which the pattern is transferred, i.e., development of the photoresist layer on the glass substrate, to form the photoresist layer in the shape corresponding to the pattern. The processing block is to process the surface of the glass substrate through the developed photoresist layer.

The color filter forming block of block S52 is to form a color filter in which a large number of sets of three dots corresponding to R (Red), G (Green), and B (Blue) are arrayed in a matrix pattern, or in which a plurality of filter sets of three stripes of R, G, and B are arrayed in a horizontal scan direction. The cell assembly block of block S54 is to assemble a liquid crystal panel (liquid crystal cell), using the glass substrate on which the predetermined pattern has been formed in block S50, and the color filter formed in block S52. Specifically, for example, a liquid crystal is poured into between the glass substrate and the color filter to form the liquid crystal panel. The module assembly block of block S56 is to attach various components such as electric circuits and backlights for display operation of this liquid crystal panel, to the liquid crystal panel assembled in block S54.

The present invention is not limited just to the application to the exposure apparatus for manufacture of semiconductor devices, but can also be widely applied, for example, to the exposure apparatus for display devices such as the liquid crystal display devices formed with rectangular glass plates, or plasma displays, and to the exposure apparatus for manufacture of various devices such as imaging devices (CCDs and others), micro machines, thin film magnetic heads, and DNA chips. Furthermore, the present invention is also applicable to the exposure block (exposure apparatus) for manufacture of masks (photomasks, reticles, etc.) on which mask patterns of various devices are formed, by the photolithography process.

The above-described embodiment uses the ArF excimer laser light (wavelength: 193 nm) or the KrF excimer laser light (wavelength: 248 nm) as the exposure light, but, without having to be limited to this, the present invention is also applicable to any other appropriate laser light source, e.g., an F₂ laser light source which supplies laser light at the wavelength of 157 nm.

In the foregoing embodiment, it is also possible to apply a technique of filling the space in the optical path between the projection optical system and the photosensitive substrate with a medium having the refractive index larger than 1.1 (typically, a liquid), which is so called a liquid immersion method. In this case, it is possible to adopt one of the following techniques as a technique of filling the space in the optical path between the projection optical system and the photosensitive substrate with the liquid: the technique of locally filling the space in the optical path with the liquid as disclosed in International Publication No. WO99/49504; the technique of moving a stage holding the substrate to be exposed, in a liquid bath as disclosed in Japanese Patent Application Laid-Open No. 6-124873; the technique of forming a liquid bath of a predetermined depth on a stage and holding the substrate therein as disclosed in Japanese Patent Application Laid-Open No. 10-303114, and so on. The teachings of International Publication No. WO99/49504, Japanese Patent Application Laid-Open No. 6-124873, and Japanese Patent Application Laid-Open No. 10-303114 are incorporated herein by reference.

The foregoing embodiment was the application of the present invention to the illumination optical system for illuminating the mask (or the wafer) in the exposure apparatus, but, without having to be limited to this, the present invention can also be applied to commonly-used illumination optical systems for illuminating an illumination target surface except for the mask (or the wafer).

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

1. A polarization converting unit arranged on an optical axis of an optical system and configured to convert a polarization state of propagation light passing along an optical-axis direction corresponding to the optical axis, the polarization converting unit comprising:
a first optical element comprised of an optical material with an optical rotatory power, which is arranged so as to have a crystal axis coincident or parallel with the optical-axis direction, the first optical element having a plurality of first regions with respective polarization conversion properties to rotate linearly polarized light incident thereto as the propagation light, around the optical-axis direction; and
a second optical element comprised of an optical material with an optical rotatory power, which is arranged on the exit side of the first optical element and which is arranged so as to have a crystal axis coincident or parallel with the optical-axis direction, the second optical element having a plurality of second regions with respective polarization conversion properties to rotate linearly polarized light incident thereto as the propagation light, around the optical-axis direction,
wherein at least two first regions selected from the plurality of first regions have their respective thicknesses different from each other in the optical-axis direction, and wherein the plurality of first regions are arranged so that two first regions with mutually different polarization conversion properties are adjacent to each other,
wherein at least two second regions selected from the plurality of second regions have their respective thicknesses different from each other in the optical-axis direction, and wherein the plurality of second regions are arranged so that two second regions with mutually different polarization conversion properties are adjacent to each other, and
wherein the first and second optical elements are arranged so that a light beam having passed through one first region of the first optical element is incident to two adjacent second regions of the second optical element, whereby the sum of respective thicknesses in the optical-axis direction of first and second regions through which a first reference axis parallel to the optical-axis direction passes is different from the sum of respective thicknesses in the optical-axis direction of other first and second regions through which a second reference axis parallel to the optical-axis direction and different from the first reference axis passes.

2. A polarization converting unit according to claim 1, wherein the plurality of first regions of the first optical element are arrayed so as to surround the optical axis along a circumferential direction corresponding to a direction of rotation around the optical axis on a plane perpendicular to the optical axis, and the plurality of second regions of the second optical element are arrayed so as to surround the optical axis along the circumferential direction around the optical axis.

3. A polarization converting unit according to claim 2, wherein the plurality of first regions of the first optical element are regions obtained by equally dividing the optical material of a circular or annular shape along the circumferential direction of the optical material,
wherein the plurality of second regions of the second optical element are regions obtained by equally dividing the optical material of a circular or annular shape along the circumferential direction of the optical material, and
wherein, when each of the first and second optical elements is viewed along the optical-axis direction from the entrance side of the first optical element, the first and second optical elements are arranged so that a boundary line between two adjacent first regions out of the plurality of first regions is optically correspondent to a center line connecting a center of an entrance surface of a corresponding second region out of the plurality of second regions, and the optical axis.

4. A polarization converting unit according to claim 1, wherein the first optical element has a plurality of optically rotatory members of a plane-parallel plate shape comprised of an optical material with an optical rotatory power, as the plurality of first regions.

5. A polarization converting unit according to claim 1, wherein the first optical element has a plurality of wave plates to convert incident light into light in a predetermined polarization state, as the plurality of first regions.

6. A polarization converting unit according to claim 1, wherein the first optical element has a plurality of polarizers to selectively transmit a light component in a predetermined polarization state from incident light, as the plurality of first regions.

7. A polarization converting unit according to claim 1, wherein the second optical element has a plurality of optically rotatory members of a plane-parallel plate shape comprised of an optical material with an optical rotatory power, as the plurality of second regions.

8. A polarization converting unit according to claim 1, wherein the second optical element has a plurality of wave plates to convert incident light into light in a predetermined polarization state, as the plurality of second regions.

9. A polarization converting unit according to claim 1, wherein the first and second optical elements are arranged in a state in which they are adjacent to each other along the optical-axis direction.

10. A polarization converting unit according to claim 1, further comprising a relay optical system arranged between the first optical element and the second optical element and making the first optical element and the second optical element optically conjugate with each other.

11. A polarization converting unit according to claim 1, the polarization converting unit being arranged in an optical path of an illumination optical system configured to illuminate an illumination target surface with light from a light source, and at or near an illumination pupil of the illumination optical system.

12. An illumination optical system configured to illuminate an illumination target surface with light from a light source, the illumination optical system comprising a polarization converting unit according to claim 1, which is arranged in an optical path between the light source and the illumination target surface.

13. An illumination optical system according to claim 12, wherein the polarization converting unit is arranged at or near an illumination pupil of the illumination optical system.

14. An illumination optical system according to claim 13, the illumination optical system being used in combination with a projection optical system for forming a plane optically conjugate with the illumination target surface, wherein the illumination pupil is arranged at a position optically conjugate with an aperture stop of the projection optical system.

15. An exposure apparatus configured to expose a photosensitive substrate to transfer a predetermined pattern thereto, the exposure apparatus comprising an illumination optical system according to claim 12 configured to illuminate the predetermined pattern.

16. An exposure apparatus according to claim 15, further comprising a projection optical system configured to form an image of the predetermined pattern on the photosensitive substrate.

17. A device manufacturing method, comprising:
exposing a photosensitive substrate to transfer a predetermined pattern thereto, using an exposure apparatus according to claim 15;
developing the photosensitive substrate to which the predetermined pattern is transferred, thereby to form a mask layer in a shape corresponding to the predetermined pattern on a surface of the photosensitive substrate; and
processing the surface of the photosensitive substrate through the mask layer.

18. A polarization converting unit arranged on an optical axis of an optical system and configured to convert a polarization state of propagation light passing along an optical-axis direction corresponding to the optical axis, the polarization converting unit comprising:
a first optically rotatory member to rotate linearly polarized light incident thereto as the propagation light, around the optical-axis direction, the first optically rotatory member being comprised of an optical material with an optical rotatory power, which is arranged so as to have a crystal axis coincident or parallel with the optical-axis direction, and having a first thickness distribution of thicknesses in the optical-axis direction different at a plurality of locations; and
a second optically rotatory member to rotate linearly polarized light incident as the propagation light thereto through the first optically rotatory member, around the optical-axis direction, the second optically rotatory member being comprised of an optical material with an optical rotatory power, which is arranged so as to have a crystal axis coincident or parallel with the optical-axis direction, and having a second thickness distribution of thicknesses in the optical-axis direction different at a plurality of locations,
wherein the first and second optically rotatory members are arranged so that the sum of respective thicknesses in the optical-axis direction at predetermined locations in the first and second optically rotatory members through which a first reference axis parallel to the optical-axis direction passes is different from the sum of respective thicknesses in the optical-axis direction at other locations in the first and second optically rotatory members through which a second reference axis parallel to the optical-axis direction and different from the first reference axis passes.

19. A polarization converting unit according to claim 18, wherein at least one of the first and second optically rotatory members is composed of a single member having a continuous surface.

20. A polarization converting unit according to claim 18, wherein at least one of the first and second optically rotatory members is composed of a single first divided member having a continuous surface and a single second divided member having a continuous surface.

21. A polarization converting unit according to claim 18, wherein at least one of the first and second optically rotatory members is surface-processed by etching at least one surface of a plane-parallel plate.

22. A polarization converting unit according to claim 18, wherein the first and second optically rotatory members are arranged so as to intersect with the optical axis, and at least one of the first and second optically rotatory members has thicknesses in the optical-axis direction varying along a circumferential direction corresponding to a direction of rotation around the optical axis on a plane perpendicular to the optical axis.

23. A polarization converting unit according to claim 18, wherein the first and second optically rotatory members are arranged so as to intersect with the optical axis, and at least one of the first and second optically rotatory members is composed of a plurality of regions divided in a circumferential direction corresponding to a direction of rotation around the optical axis on a plane perpendicular to the optical axis, the plurality of regions being arranged so that two regions having respective thicknesses different in the optical-axis direction are adjacent to each other.

24. A polarization converting unit according to claim 23, wherein each of the plurality of regions has a contour obtained by dividing the optical material of a circular or annular shape along a circumferential direction of the optical material.

25. A polarization converting unit according to claim 18, wherein the first and second optically rotatory members have the same structure.

26. A polarization converting unit according to claim 25, wherein, when the first and second optically rotatory members are viewed along the optical-axis direction, the first and second optically rotatory members are arranged so that the first thickness distribution is coincident with the second thickness distribution.

27. A polarization converting unit according to claim 18, wherein at least one of the first and second optically rotatory members is comprised of quartz crystal.

28. A polarization converting unit according to claim 18, wherein the first and second optically rotatory members are arranged in a state in which they are adjacent to each other along the optical-axis direction.

29. A polarization converting unit according to claim 18, the polarization converting unit being arranged in an optical path of an illumination optical system for illuminating an illumination target surface with light from a light source, and in a pupil space including an illumination pupil of the illumination optical system.

30. A polarization converting unit according to claim 18, wherein each of the first and second thickness distributions is a distribution in which, along with position information of portions in the optical material, thicknesses in the optical-axis direction of the respective portions are made correspondent on a plane perpendicular to the optical-axis direction, and nonuniform distribution.

31. An illumination optical system configured to illuminate an illumination target surface with light from a light source, the illumination optical system comprising a polarization converting unit according to claim 18, which is arranged in an optical path between the light source and the illumination target surface.

32. An illumination optical system according to claim 31, wherein the polarization converting unit is arranged in a pupil space including an illumination pupil of the illumination optical system.

33. An illumination optical system according to claim 32, the illumination optical system being used in combination with a projection optical system for forming a plane optically conjugate with the illumination target surface, wherein the illumination pupil is arranged at a position optically conjugate with an aperture stop of the projection optical system.

34. An exposure apparatus configured to expose a photosensitive substrate to transfer a predetermined pattern thereto, the exposure apparatus comprising an illumination optical system according to claim 31 configured to illuminate the predetermined pattern.

35. An exposure apparatus according to claim 34, further comprising a projection optical system configured to form an image of the predetermined pattern on the photosensitive substrate.

36. A device manufacturing method, comprising:
exposing a photosensitive substrate to transfer a predetermined pattern thereto, using an exposure apparatus according to claim 34;
developing the photosensitive substrate to which the predetermined pattern is transferred, thereby to form a mask layer in a shape corresponding to the predetermined pattern on a surface of the photosensitive substrate; and
processing the surface of the photosensitive substrate through the mask layer.
